(19) United States
(12) Patent Application Publication
(10) Pub. No.: US 2007/0086349 A1
(43) Pub. Date: Apr. 19, 2007

(54) Network apparatus, method of self-testing network connectivity, and method of analyzing frequency spectrum

(75) Inventor: I-Ru Liu, Taipei (TW)

Correspondence Address: BIRCH STEWART KOLASCH & BIRCH, PO BOX 747, FALLS CHURCH, VA, 22040-0747, US

(73) Assignee: Arcadyan Technology Corporation

(21) Appl. No.: 11/251,864

(22) Filed: Oct. 18, 2005

(51) Int. Cl. H04L 12/26

(52) U.S. Cl. 370/241

(57) ABSTRACT

A network apparatus for self-testing network connectivity, a method thereof, and a method of analyzing frequency spectrum. The invention includes a link mode and a diagnostic mode. In the diagnostic mode, the MAC self-tests the network apparatus for network connectivity at least in signal quality, link quality, and quality of service by generating output signals traveling from the transmitter to the receiver, thus providing a simple, low power consuming, and reliable means for troubleshooting errors. The method of analyzing frequency spectrum eliminates the need of an expensive spectrum analyzer by utilizing the transmitter to output signals detectable by the receiver, then calculating power level differences between selected channel and its adjacent channels of the channels assigned to the receiver, and comparing the calculated power level differences with a plurality of pre-determined threshold values stored in a memory controlled by the MAC in order to meet standards and specifications.

### BACKGROUND OF THE INVENTION

1. Field of the Invention

The invention relates in general to a network apparatus, and more particularly to a network apparatus for self-testing network connectivity, and a method thereof, and a method of analyzing frequency spectrum.

2. Description of the Related Art

Conventionally, testing network connectivity of a network device requires the support of an external test system. FIG. 1 shows a system block diagram of a conventional network device. The network device 100 includes a receiver 110 (denoted as RX), a transmitter 120 (denoted as TX), a voltage controlled oscillator (VCO) 130, a media access control (MAC) with baseband processor (BBP) 140, a transmitter/receiver switch 150, and an antenna 160. The receiver 110 and the transmitter 120 are both driven by the same VCO 130 operating under a time division duplex system (TDD), in which a common carrier is shared between uplink and downlink. To transmit signals, the transmitter/receiver switch 150 connects the transmitter 120 to the antenna 160, such that signals generated by MAC 140 can be transmitted to a network 170; to receive signals from the network, the transmitter/receiver switch 150 instead connects the antenna 160 to the receiver 110.

To test for network connectivity, network device 100 is connected to an external test system. FIG. 2 shows a block diagram of an external test system. The external test system includes test controllers 210 and 240, a spectrum analyzer 220, a power meter 230, power couplers 250 and 260, an attenuator 270, and a signal generator 280. Test controller 210,, such as personal computers with test utilities, is for controlling the network device 100, spectrum analyzer 220 and power meter 230. Test controller 240, such as personal computers with test utilities, is for controlling the signal generator 280. To check for signal characteristics from the receiver 110, the signal generator 280 generates an output signal that travels through the attenuator 270 emulating channel attenuation and eventually reaches the receiver 110 of the network device 100 under test. The couplers 250 and 260 direct the output signals to the spectrum analyzer 220 and the power meter 230, respectively, to thereby monitor the associated signal. To test for characteristics of signals originated from the transmitter 120, test controller 210 operates on the transmitter 120 so as to transmit output signals, which propagate in a direction that is to be measured and analyzed by the spectrum analyzer 220 and power meter 230. The analyzed results can, for instance, then be shown on a display of test controller 210 for view by a user.

To reduce the need for a bulky external test system, a built-in test system has thus been devised to incorporate the capabilities for testing network connectivity within network device 100. FIG. 3 shows a conventional network device with a built-in test system. As shown in the figure, the functions of the traditional test equipments in FIG. 2, including signal generator 280, spectrum analyzer 220, power meter 230, power couplers 250 and 260, attenuator 270, and test controllers 210 and 220 have been embedded in the built-in test system 300 with corresponding signal generator 380, spectrum analyzer 320, power meter 330, power coupler 350, attenuator 370, and test controller 310, respectively, thus reducing the trouble and need for the presence of numerous test equipments.

In addition to a transmitter/receiver switch 150, the network device 300 further includes a stimulus/antenna switch 340 and a monitor/antenna switch 360, for use in establishing connection between the two selected from the group consisting of the transmitter 120 denoted as TX, receiver 110 denoted as RX and antenna 160. Namely, the network device 300 performs network connectivity tests during a normal transmit mode, a normal receive mode and a built-in-test mode for respective transmitter and receiver testing. During the normal receive mode, the receiver 110 is active. The transmitter/receiver switch 150 and the stimulus/antenna switch 340 are configured so as to allow signals from network 170 to reach the receiver 110. During the normal transmit mode, the transmitter 120 is active. The transmitter/receiver switch 150 and monitor/antenna switch 360 connects the transmitter 120 to the antenna 160, thus allowing signals, generated by transmitter 120, to be transmitted over network 170. During built-in-test mode, either the transmitter 120 or the receiver 110 are active; the monitor/antenna switch 360 is configured so as to allow signals transmitted from the transmitter 120 to travel through attenuator 370, in which the signals are in turn split by power coupler 350 and received by the spectrum analyzer 320 and power meter 330 for evaluation of signal strength and other related signal qualities; also, the stimulus/antenna switch 340 is configured such that the signals generated by the signal generator 380 reaches the receiver 110. Thus, by applying the testing scheme adapted for the network device with a built-in test system, the associated network connectivity can be tested for without the troubles accompanied with an external test system.

However, while the conventional network device with a built-in test system may be applicable for use in military applications and satellite systems etc., the conventional network device has a complex architecture, which greatly reduces reliability, and is expensive and power consuming. The built-in test system also increases overall packaging size and weight of the network device, which are factors that all likely to be unsuitable for use in office and household applications.

### SUMMARY OF THE INVENTION

It is therefore an object of the invention to provide a simpler architecture for self-testing network connectivity.

It is yet another object of the invention to provide a less power consuming network apparatus by self-testing network connectivity.

It is yet another object of the invention to provide a more economic network apparatus.

It is yet another object to the invention to provide a simpler way of analyzing frequency spectrum of signals received by the receiver.

The invention achieves the above-identified objects by providing a network apparatus that includes a receiver, a transmitter, an antenna, and a media access control (MAC) with baseband processor. The invention is characterized in that the network apparatus includes a link mode and a diagnostic mode. In the link mode, the network apparatus connects to a network via the antenna. In the diagnostic mode, the media access control self-tests the network apparatus for network connectivity by generating output signals traveling from the transmitter to the receiver.

The invention achieves the above-identified objects by further providing a method of self-testing network connectivity applied in a network apparatus. The network apparatus includes a receiver, a transmitter, an antenna, and a media access control (MAC) with baseband processor. The method includes: first, outputting by the transmitter a plurality of output signals to the receiver; then, optimizing transmission capability by tuning the transmitter, such that the output signals are output substantially at a predetermined maximum power level satisfying a predetermined transmitter packet error rate (PER); next, checking reception capability by tuning the transmitter, such that the output signals are output substantially at a predetermined minimum power level satisfying a predetermined receiver PER; and, double-checking crosslink capability by tuning the transmitter to output signals with a rated or an average crosslink power level to see if it satisfies a predetermined link quality indicator (LQI) and a predetermined indicator of quality of service (IQoS).

The invention achieves the above-identified objects by further providing a method of analyzing frequency spectrum while optimizing transmission capability of spectrum mask fitting, applied in a network apparatus for self-testing network connectivity. The method includes: transmitting a plurality of output signals at a high-limit power level by a selected channel of the transmitter; then, receiving the output signals by the assigned channels of the receiver, the assigned channels include the selected channel of the transmitter and all its adjacent ones; next, calculating received power level differences of those adjacent channels from the selected channel; and, comparing the calculated power level differences with a plurality of pre-determined threshold values stored in a memory controlled by the media access control.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 shows a system block diagram of a conventional network device.

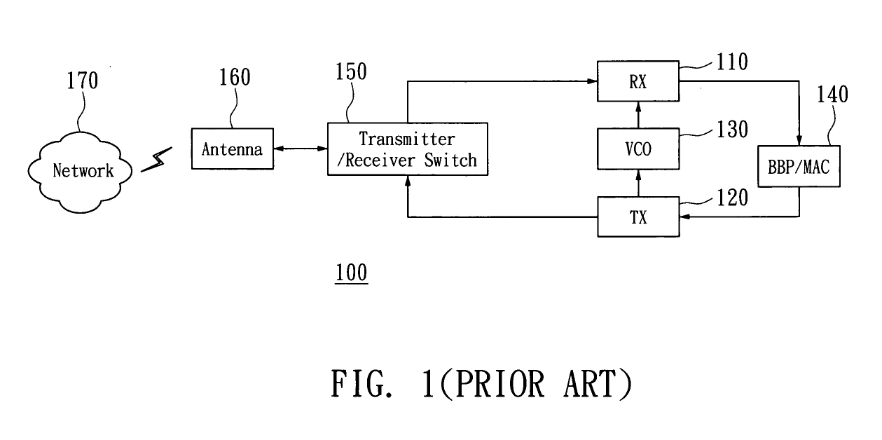

FIG. 2 shows a block diagram of a conventional external test system.

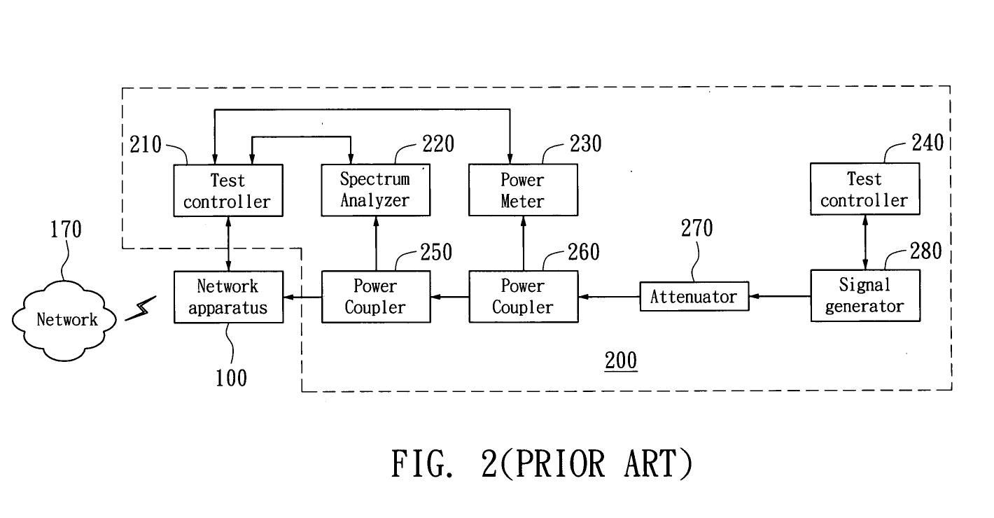

FIG. 3 shows a conventional network device with a built-in test system.

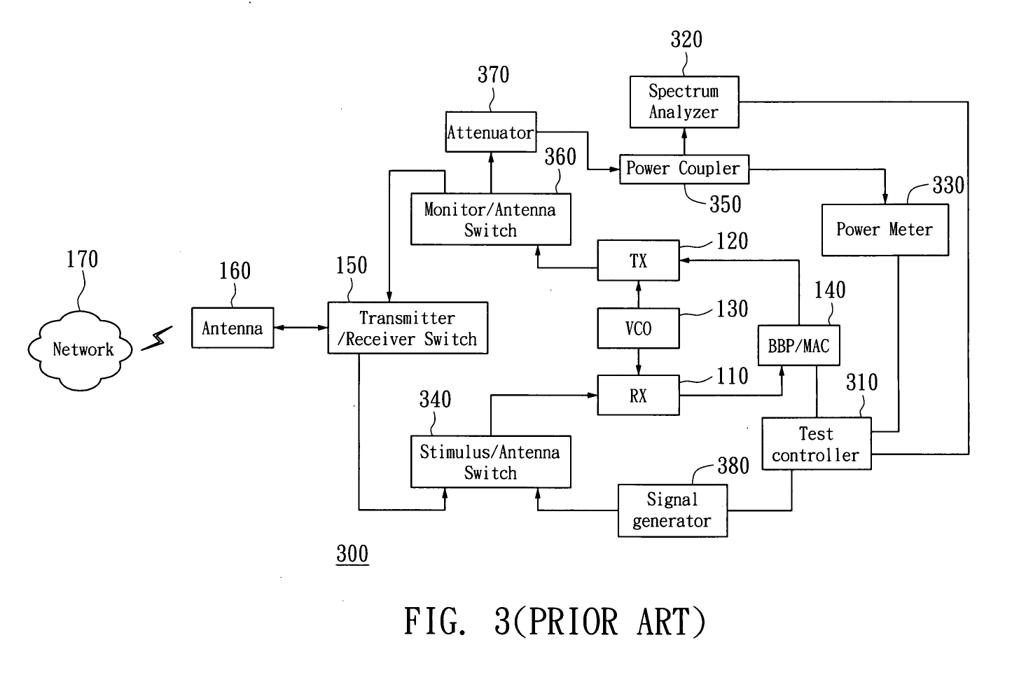

FIG. 4 illustrates a functional block diagram of the network apparatus according to the invention.

FIG. 5A illustrates a network apparatus according to a first embodiment of the invention.

FIG. 5B illustrates the mode selection table for the network apparatus 500 of FIG. 5A under test.

FIG. 6A illustrates a network apparatus according to a second embodiment of the invention.

FIG. 6B shows a mode selection table for the network apparatus of FIG. 6A under test.

FIG. 7 shows a block diagram of the mutual network connectivity test between two network apparatuses according to a preferred embodiment of the invention.

FIG. 8 shows a method of self-testing network connectivity applied in the network apparatus 500 according to a preferred embodiment of the invention.

FIG. 9 shows the sub-steps of step 810 in optimizing uplink capability.

FIG. 10 shows the sub-steps of step 820 in optimizing downlink capability.

FIG. 11 shows a flow chart of the sub-steps of step 830 in optimizing crosslink capability.

FIG. 12 shows a method of analyzing frequency spectrum according to a preferred embodiment of the invention.

FIGS. 13A-D illustrate plots of the outputs signals transmitted by the transmitter.

### DETAILED DESCRIPTION OF THE INVENTION

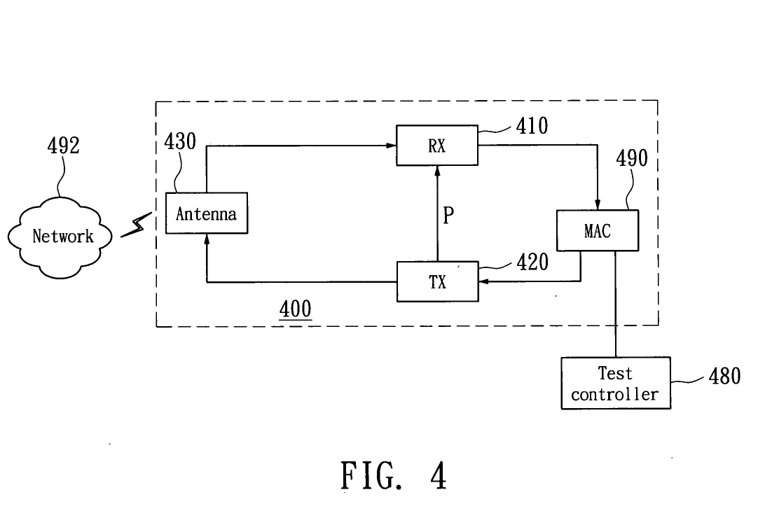

FIG. 4 illustrates a functional block diagram of the network apparatus according to the invention. The network apparatus 400 includes a receiver 410, a transmitter 420, an antenna 430, and a media access control (MAC) 490. For self-testing network connectivity, the network apparatus 400 operates under a full duplex system. That is, the network apparatus 400 includes a first voltage-controlled oscillator (VCO) and a second VCO for controlling the transmitter 420 and the receiver 410, respectively. The network apparatus 400 includes a link mode and a diagnostic mode. In the link mode, the network apparatus 400 establishes connection to a network 492 via the antenna 430. Instead of the conventional signal generator, the invention utilizes the transmitter 420 to transmit output signals generated by the MAC 490 as the stimulus for the purpose of self-testing network connectivity. In the diagnostic mode, both the transceiver and the receiver are both involved, in which the output signals transmitted from the transmitter to the receiver are analyzed. That is, in the diagnostic mode, the MAC 490 is to generate output signals that contain test signals in packets, frames or other formats, in which the output signals travel then along a signal path P from the transmitter 420 to the receiver 410 to be tested for network connectivity characteristics at least in signal quality, link quality, and quality of service (QOS).

### First Embodiment

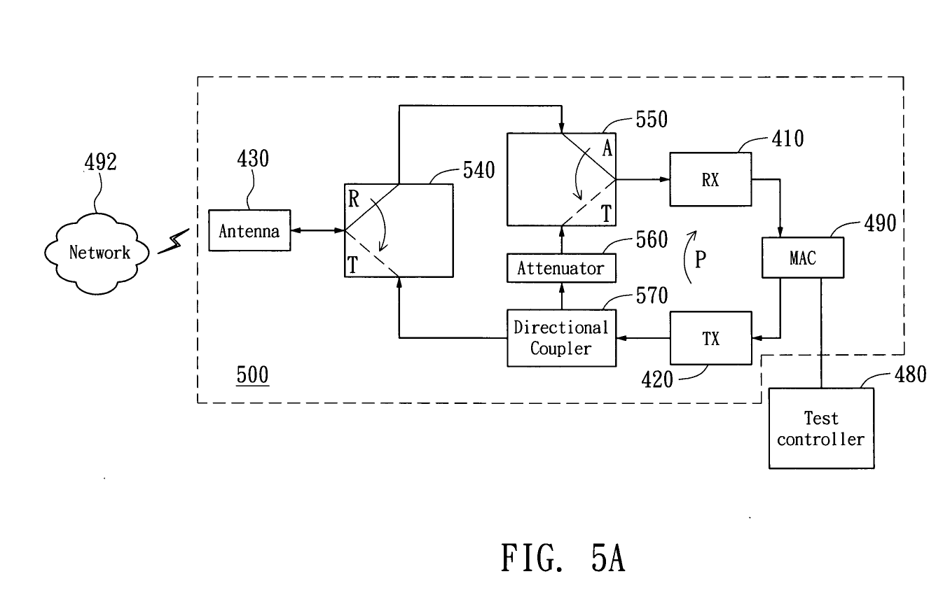

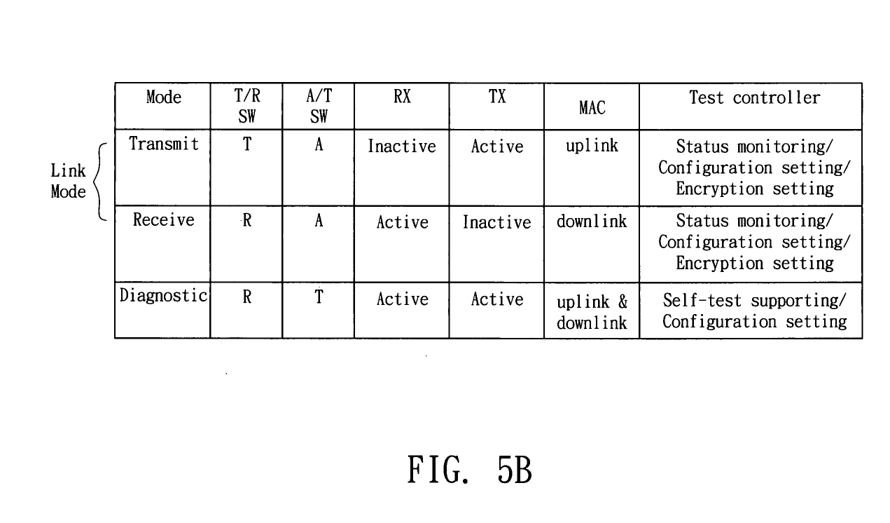

FIG. 5A illustrates a network apparatus according to a first embodiment of the invention. The network apparatus is a network capable device, such as a network interface card (NIC) 500. Under the link mode, the NIC 500 further operates under a transmit mode and a receive mode. The NIC 500 includes a first switch, such as a transmitter/receiver (T/R) switch 540, which operates under a predetermined protocol, and is configured such that the output signals from the transmitter 420 are transmitted to the network 492 in the transmit mode, and the incoming signals from the network 492 reaches the receiver 410 in the receive mode. The NIC 500 further includes a second switch, such as an antenna/transmitter (A/T) switch 550, an attenuator 560, and a directional coupler 570 inter-disposed on the signal path P between the transmitter 420 and the receiver 410. The attenuator 560 is for emulating channel attenuation. The AFT switch 550 operates to connect the attenuator 560 to the receiver 410 in the diagnostic mode, and the output signals travel from the transmitter 420 to the receiver 410 via the order of passing through the directional coupler 570 and the attenuator 560. The concept of switching is illustrated in FIG. 5B, showing the mode selection table for the network apparatus 500 of FIG. 5A under test.

As shown in FIG. 5A, the T/R switch 540 can be selectively switched between position R and T, and the AFT switch 550 can be selectively switched between position A and T. The switching of the T/R switch 540 and A/Tswitch 550 depends on the modes of operation, i.e. link mode or diagnostic mode, under the control of a pre-determined protocol. That is, during the link mode, particularly, the transmit mode, the MAC 490 is to perform an uplink to the network 492 via the transmitter 420. Hence, as shown in FIG. 5B, transmitter 420 is active and the T/R switch 540 and the A/T switch 550 are switched to positions T and A respectively. By such arrangements, the output signals generated by the MAC 490 can be ensured to travel from the transmitter 420 to the directional coupler 570 and through the antenna 430 out to the network 492, and not arriving at the receiver 410.

In the receive mode, the MAC 490 is to downlink signals from the network 492. Hence, the T/R switch and the A/T switch are, switched to positions R and A, respectively, such that incoming signals from the network 492 travel via the antenna 430 to the receiver 410 and is processed by the MAC 490 accordingly. Additionally, MAC 490 can also be in a crosslink with the network 492 such that the network apparatus 500 is operating successively between the transmit mode and the receive mode.

Under the diagnostic modes, as shown in FIG. 5B, both the transmitter 420 and the receiver 410 are active, and the T/R switch and the A/T switch are switched, under the predetermined protocol, to positions R and T respectively such that signals travel on the signal path P from the transmitter 420 to the receiver 410 via passing through the directional coupler 570 and the attenuator 560. The predetermined protocol is for preferably a link logic control (LLC).

Preferably, the network apparatus 500 is applied in a device controlled by a test controller 480, such that the device is for instance a personal computer controlled by a test utility thereof. The test controller 480 is for controlling the network apparatus 500 to monitor connection status and make configuration and encryption settings to the transmitter 420 and the receiver 410.

The diagnostic mode further includes a transmit self-test mode, a receive self-test mode, and a crosslink self-test mode for testing different network connectivity characteristics of the network apparatus 500. There are many signal quality parameters that are indicative of the network connectivity, and the below list is not exhaustive. For signal quality, for instance, one can observe receive signal strength indicator (RSSI) and signal quality indicator in packet error rate (PER), to determine receiver maximum and minimum output powers or observe relative signal strength indicators (SSI); one can observe transmit signal strength indicator (TSSI) and signal quality indicator in packet error rate (PER) or error vector magnitude (EVM), or spectrum mask, to determine transmitter maximum and minimum output powers. For link quality, one can observe link quality indicators (LQI) in uplink/downlink throughputs or uplink/downlink packet loss rates and packet loss periods etc. For quality of service QoS, one can observe indicators of QoS (IQoS) in uplink/downlink delays and uplink/downlink jitters etc.

In the transmit self-test mode, the MAC 490 is to tune the transmitter 420 such that the output signals are output substantially at a predetermined maximum power level satisfying a predetermined transmitter packet error rate (PER) such that the transmitter output power is optimized. In the receive self-test mode, the media access control (MAC) 490 is to tune the transmitter 420 such that the output signals are output substantially at a predetermined minimum power level satisfying a predetermined receiver PER, such that the receiver sensitivity is checked. In the crosslink self-test mode, the media access control (MAC) 490 is to tune the transmitter 420 such that the output signals are output at a rated or an average crosslink power level satisfying a predetermined LQI and a predetermined IQoS, such that the link quality and the quality of service are checked.

Although in the first embodiment the invention has been demonstrated with the output signals being tested against a predetermined transmitter PER, in the transmit self-test mode, to optimize transmitter output power, the output signals can alternatively be tested against a predetermined transmitter EVM, or spectrum mask etc.

### Second Embodiment

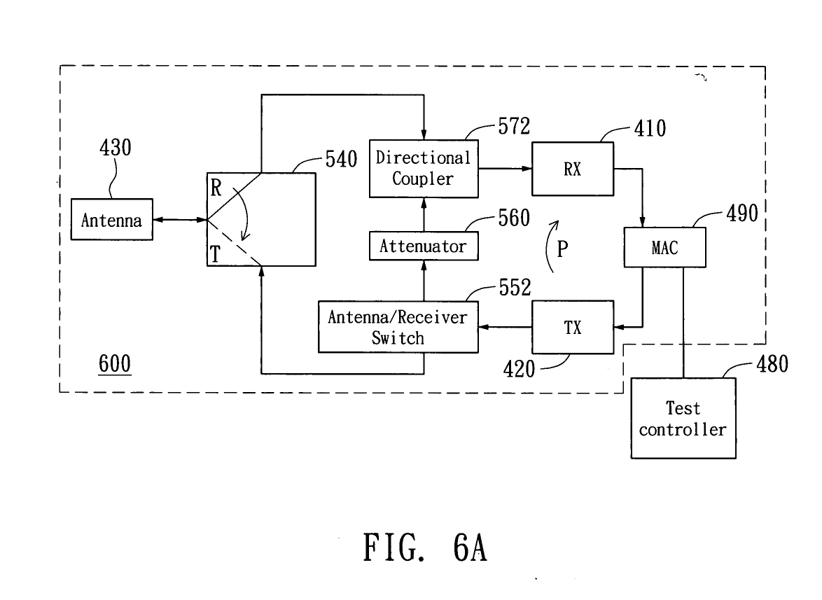

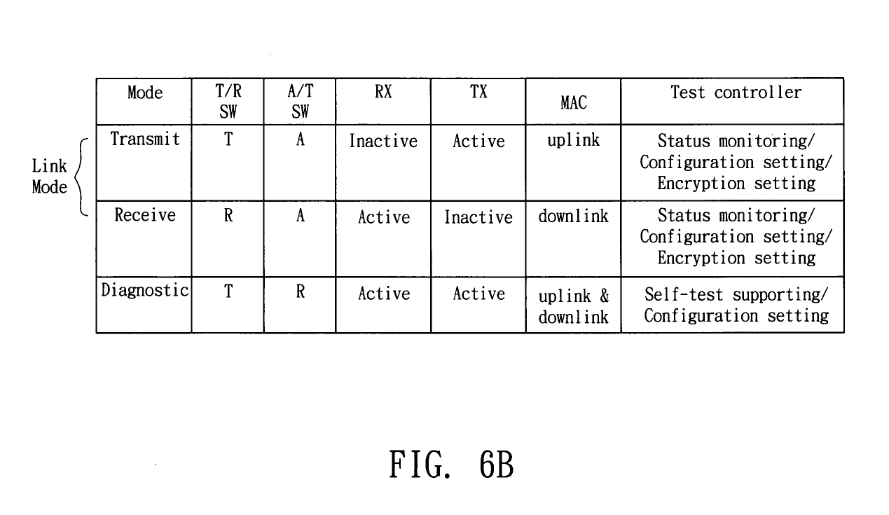

FIG. 6A illustrates a network apparatus according to a second embodiment of the invention. The second embodiment is distinguished from the first embodiment in that, the network apparatus 600 includes a directional coupler 572, an attenuator 560, and a second switch (such as an antenna/receiver (A/R) switch 552) that are inter-disposed on the signal path P between the transmitter 420 and the receiver 410, such that when the A/R switch 552 connects the transmitter 420 to the attenuator 560 in the self-test mode, the output signals travel from the transmitter 420 to the receiver 410 instead via the order of passing through the attenuator 560 and the directional coupler 572.

FIG. 6B shows a mode selection table for the network apparatus of FIG. 6A under test. The A/R switch 552 operates similar to the A/T switch 550 of FIG. 5A. The notable distinction is that, under the diagnostic mode, the T/R switch 540 is instead switched to position T to avoid the incoming signals from the network 430 also traveling to the receiver 410.

As shown, the first and the second embodiments of the invention are cost-effective by simplifying and embedding the conventional test equipments into the network apparatus 500. The transmitter and the receiver can be used in the diagnostic mode to check for device functionality. That is, if an apparent error has occurred from the network connectivity test, then it can be inferred that at least one of the transmitter 420 or the receiver 410 may be malfunctioning and the transmitter-receiver pair can be removed and replaced accordingly. Also, the network apparatus according to the embodiments of the invention are relatively cheaper, lighter in weight, and less power consuming, and due to less complexity, are also less prone to errors. Thus, the network apparatus according to the embodiment of the invention is especially viable commercially in that the manufacturer and even the buyer can diagnose the network apparatus in all network levels, including the PHY and MAC layers, to troubleshoot errors without expensive test equipments.

Applications

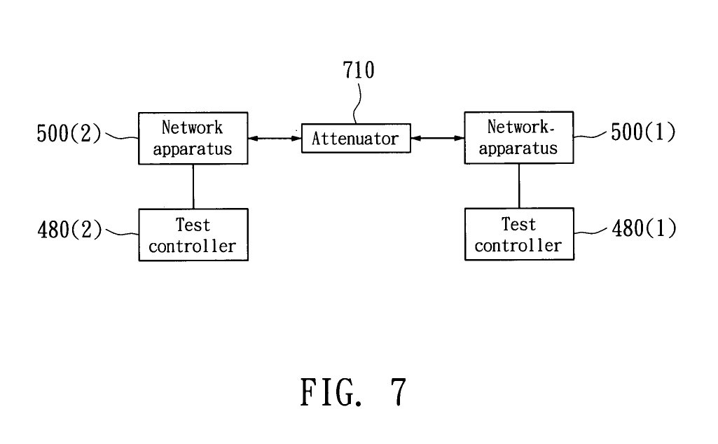

Additionally, the test controller 480 can utilize the network apparatus 500 to connect the device to another one of said device having another one of said network apparatus applied therein, for performing mutual network connectivity between the two network apparatuses. FIG. 7 shows a block diagram of the mutual network connectivity test between two network apparatuses according to a preferred embodiment of the invention. The mutual network connectivity test involves network apparatuses 500(1) and 500(2), test controller 480(1) and 480(2) and an attenuator 710. As shown in the figure, the network apparatus 500(1), such as one shown in FIG. 5A, is controlled by the test controller 480(1) and used as a reference device to test network connectivity of the network apparatus 500(2), by sending output signals that travel through the attenuator 710 emulating channel attenuation. Alternatively, the network apparatus 500(2) can then subsequently used as the reference device to test network connectivity of the network apparatus 500(1), i.e. the two can be used as reference devices interchangeably for mutual network connecting testing.

In addition to being applied in a client station, for example a personal computer controlled by a test utility thereof, the network apparatus can also be applied in an embedded station in a basic service set (BSS), while the test controller serves as an access point (AP) in the BSS servicing the embedded station. The network apparatus can further be applied in an AP in an extended service set (ESS), while the test controller acts as a server center in the ESS servicing the AP.

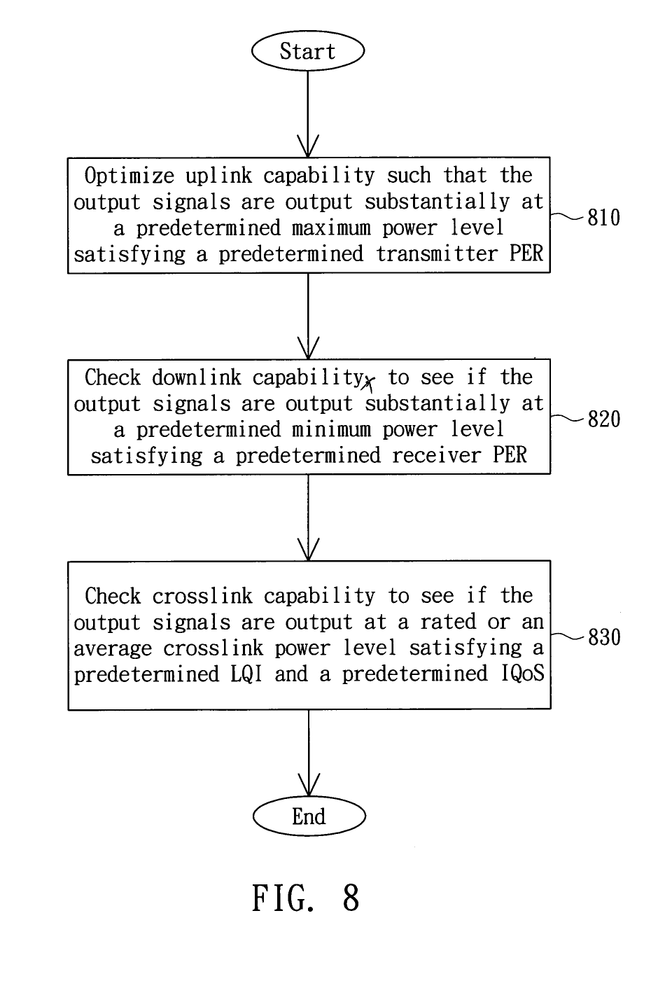

Additionally, a method of self-testing network connectivity applied in the network apparatus, such as network apparatus 500, is proposed. FIG. 8 shows a preferred embodiment of the method of self-testing network connectivity. First, in the transmit self-test mode, the transmitter 420 is tuned to optimize uplink capability, such that the output signals are output substantially at a predetermined maximum power level satisfying a predetermined transmitter packet error rate (PER), as indicated by step 810. The predetermined transmitter PER can for instance be stored in a solid-state memory of the device in which the network apparatus is applied. Then, in the receive self-test mode, the transmitter 420 is tuned to check downlink capability, such that the output signals are output substantially at a predetermined minimum power level satisfying a predetermined receiver PER, as shown by step 820. To simulate the typical power of uplink and downlink traffic of the network apparatus in a link mode, step 830 is performed under the crosslink self-test mode to tune the transmitter 420 such that the output signals are output at a rated or an average crosslink power level. The transmitter is checked to see if the rated or average crosslink power level satisfies a predetermined link quality indicator (LQI) and a predetermined indicator of quality of service (IQoS).

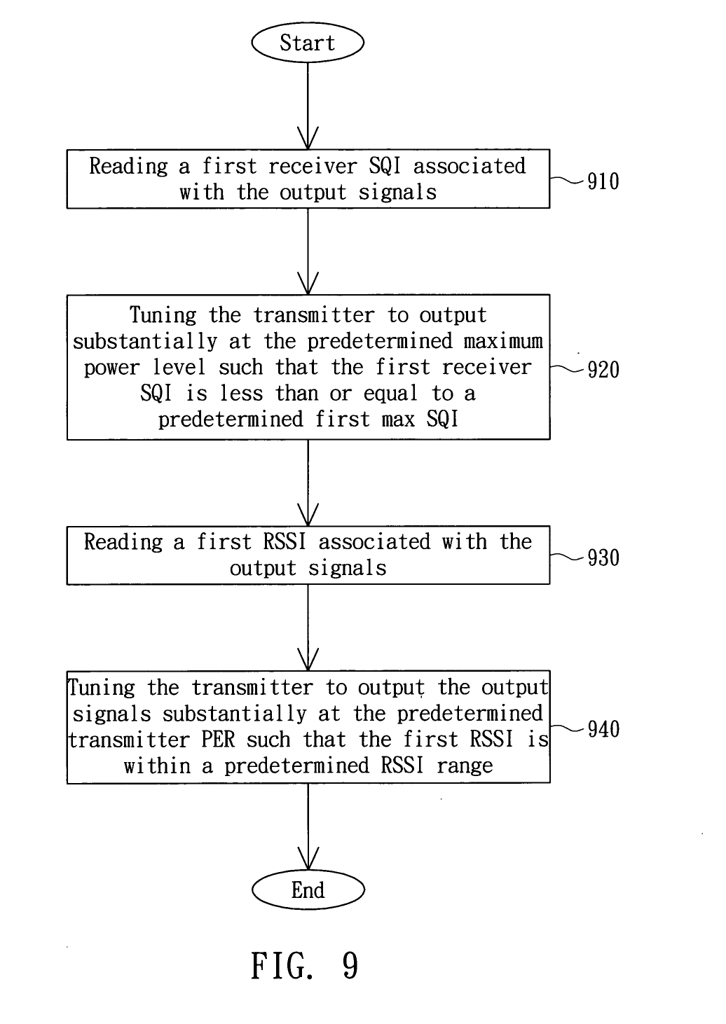

The step 810 of optimizing uplink capability can include additional steps. FIG. 9 shows the sub-steps of step 810 in optimizing uplink capability. First, step 910 is performed to read the output signals by the receiver 410 to obtain a first receiver signal quality indicator (SQI). For distant communications, it is important that the output power of the transmitter must be strong enough to ensure transfer quality. Thus, step 920 is performed to tune the transmitter 420 to output substantially at the predetermined maximum power level such that the first receiver SQI is less than or equal to a predetermined first max SQI. Since it is also important to have adequate minimum output power, such that in circumstances in which the network apparatus is, for instance, applied in a client station and is in close proximity with an AP, the transmitter 420 may be additionally tuned to output the output signals substantially at a predetermined minimum output power level such that the first receiver SQI is less than or equal to a predetermined first min SQI (step not shown). To optimize downlink capability, transmitter PER is preferably checked along with the transmitter maximum power level test of step 920; the two factors are trade-offs of each other, and there is a limit to the strength of the maximum output power. That is, if the output power of the transmitter 420 is increased to saturation, signals in OFDM (orthogonal frequency division multiplexing) and QAM (quadrature amplitude modulation), for instance, can become worse due to transmitter nonlinearity that the associated PER increases significantly.

Consequently, step 930 is performed to read a first receiver signal strength indicator (RSSI) from the output signals. Thereafter, step 940 is performed to tune the transmitter 420 to output the output signals substantially at the predetermined transmitter PER, such that the first RSSI is within a predetermined RSSI range preferably having a lower limit of 18 dBm and an upper limit of 20 dBm. The transmitter 420 is tuned limiting the PER of the output signals within the predetermined RSSI range in order to ensure that the signal strength satisfies the associated Wi-Fi standard, EMI/FCC requirements, and other factory specifications.

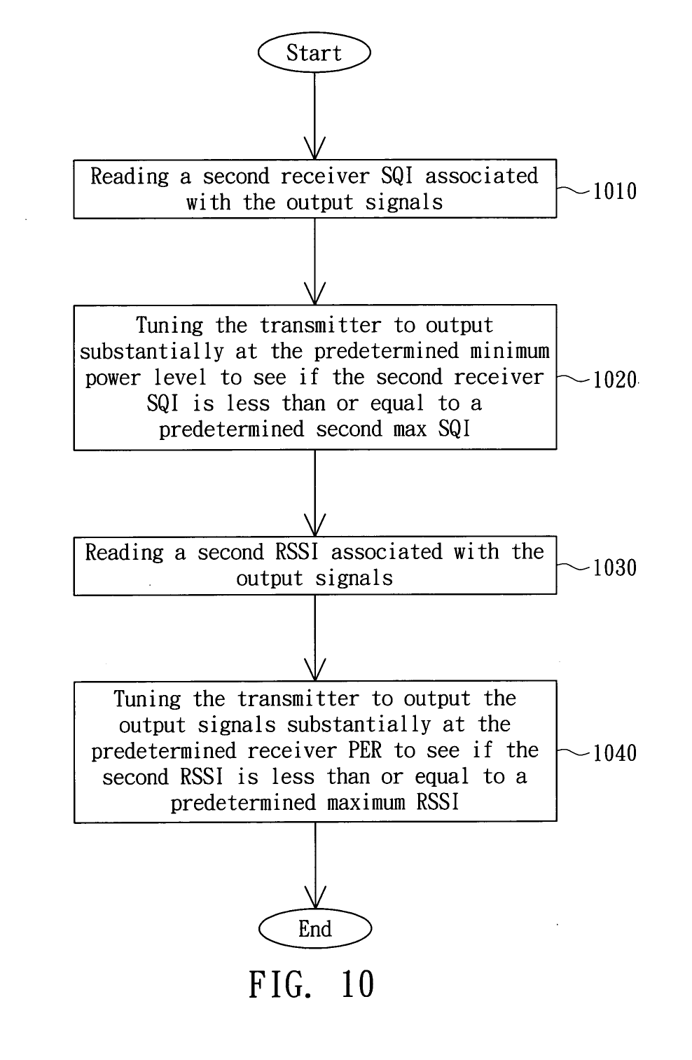

FIG. 10 shows the sub-steps of step 820 in checking downlink capability. In the receive self-test mode, a second receiver signal quality indicator (SQI) associated with the output signals is read from the receiver 410, as shown in step 1010. The transmitter 420 is then tuned to output substantially at the predetermined minimum power level such that the second receiver SQI, when read from the output signals at the receiver 410 for checking receiver sensitivity, is less than or equal to a predetermined second max SQI, as shown in step 1020. As analogous to the transmit self-test mode, due to trade-off relationship, the receiver PER in the receive self-test mode is preferably tested jointly with the receiver sensitivity step 1020. Consequently, a second receiver signal strength indicator (RSSI) associated with the output signals is read from the receiver 410, as shown in step 1030, and the transmitter is tuned to output the output signals substantially at the predetermined receiver PER such that the second RSSI is less than or equal to a predetermined maximum RSSI, as shown in step 1040. Since it is also important to have adequate maximum input power, such that in circumstances in which the network apparatus is, for instance, applied in a client station and is in close proximity with an AP, the transmitter 420 may be additionally tuned to output the output signals substantially at a predetermined maximum input power level such that the second receiver SQI is less than or equal to a predetermined second min SQI (step not shown). That is, if the input power of the receiver 410 is increased to saturation, signals in OFDM (orthogonal frequency division multiplexing and QAM (quadrature amplitude modulation), for instance, can become worse due to receiver nonlinearity that the associated PER increases significantly.

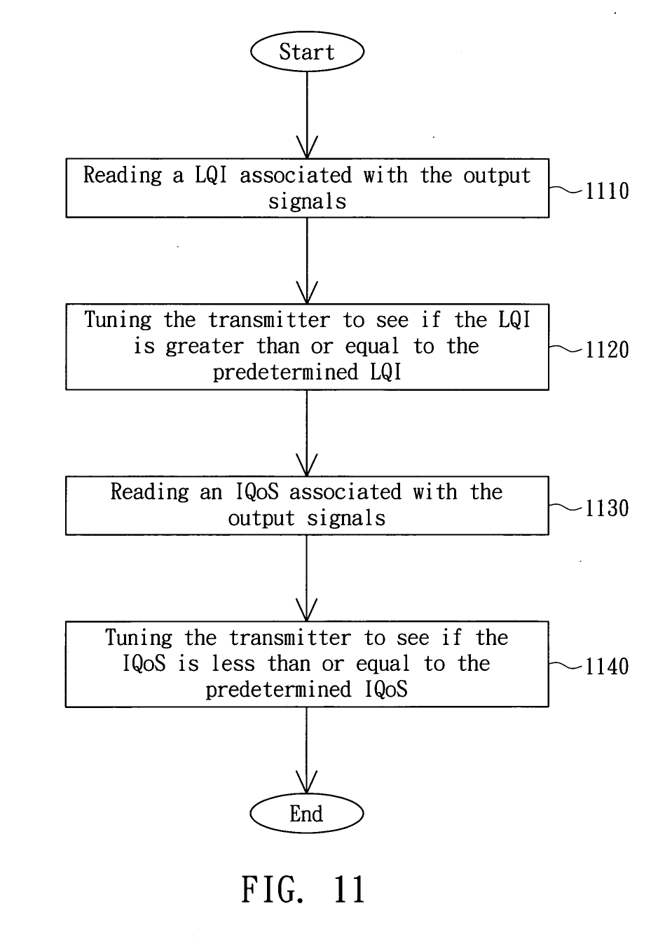

FIG. 11 shows a flow chart of the sub-steps of step 830 in checking crosslink capability. First, under the crosslink self-test mode, step 1110 is performed to read link quality indicator (LQI) associated with the output signals at the receiver 410. The transmitter is tuned at a rated or an average power level to see if the LQI is greater than or equal to the predetermined LQI, as shown in step 1120. In cases when the output signals contain time dependent data i.e. audio/video data, it is important to check, in addition to link quality and signal quality, for the quality of service so as to ensure no delays or jitters to the audio/video during the transfer. Thus, as shown in step 1130, an indicator of quality of service (IQoS) associated with the output signals is read from the receiver 410, and the transmitter is then tuned at a rated or an average power level to see if the IQoS is less than or equal to the predetermined IQoS, as shown in step 1140.

To overcome conventional needs for the presence of an expensive spectrum analyzer, which comes at the price of tens of thousands, to analyze frequency spectrum of the output signals, a novel method of analyzing frequency spectrum is proposed. The invention reconstructs the frequency spectrum by summing the output signals at the side of receiver 410, where the output signals are transmitted from the respective channels assigned to the transmitter 420. The channels often have reserved overlap regions; as a result, the output signals reconstructed, by combining frequency-domain mainbeam and sidelobe patterns detected from individual channels, may not appear identical to one constructed from a spectrum analyzer. However, it bears enough resemblance to be useful in determining whether the output signals reconstructed meets, for instance, the specification of an 802.11g standard, by checking the power level differences of the output signals with a plurality of predetermined threshold values.

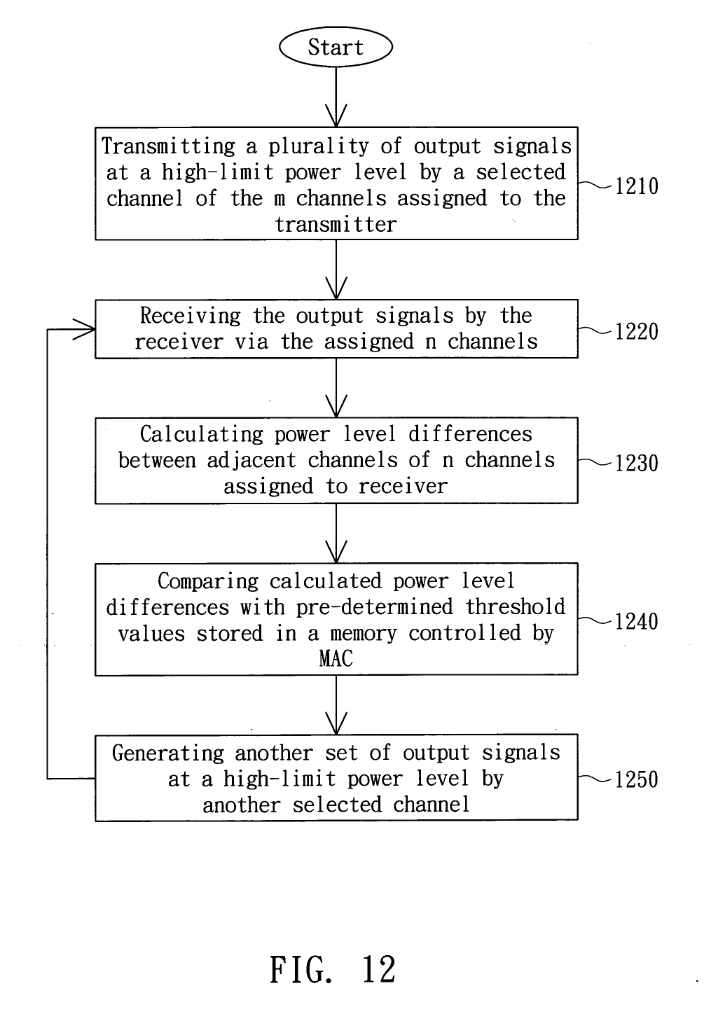

FIG. 12 shows a method of analyzing frequency spectrum according to a preferred embodiment of the invention. The method is applied in a network apparatus for self-testing network connectivity, such as one shown in FIG. 5A. The network apparatus 500 includes a plurality of channels per each radio (transmitter or receiver). The total channel number is increased if dual-band (or tri-band; or quad-band) transmitter or receiver is used in a combo network apparatus. The total channel number is double (or triple; or quadruple) if two (or three; or four) transmitters or receivers are used in a multiple-input-multiple-output (MIMO) network apparatus. For instance and as a basic example, in an IEEE 802.11b wireless LAN system, the frequency band is divided into 11 overlapped channels of 22 megahertz (MHz) each. The transmitter 420 and the receiver 410 are assigned m and n channels of the plurality of channels, respectively, where m and n are positive integers. Generally, integers m and n are set to be equal. The method of analyzing frequency spectrum begins at step 1210, in which the transmitter 420 transmits, by a selected channel of the m channels assigned to the transmitter 420, a plurality of output signals at a high-limit power level. The output signals are transmitted at a high-limit power in order for the receiver 410 to be able to detect the lowest sidelobes of the frequency domain pattern formed by the output signals, which are often low in power. At step 1220, the receiver 410 receives the output signals via the n channels assigned to the receiver 410, for measuring corresponding power level at each channel of the n channels assigned to the receiver 410. Then, step 1230 is performed to calculate power level differences between the received power of the channel of the n channels assigned to the receiver 410, which corresponding to the channel of the m channels assigned to the transmitter 420, and the received powers of the adjacent channels. At step 1240, the calculated power level differences, collectively forming a frequency spectrum, are compared with a plurality of pre-determined threshold values of spectrum mask, stored in a memory controlled by the media access control 490, such as the solid-state memory in the device of which the network apparatus 500 is applied. Then, step 1250 is performed to generate another set of output signals at a high-limit power level by another selected channel of the remaining m channels assigned to the transmitter 420 and step 1220 is returned. That way, by generating output signals sequentially one by one from the m channels assigned to the transmitter 420, and then subsequently having the output signals received simultaneously by all the n channels assigned to the receiver 410, the plurality of frequency spectra of the output signals can be constructed.

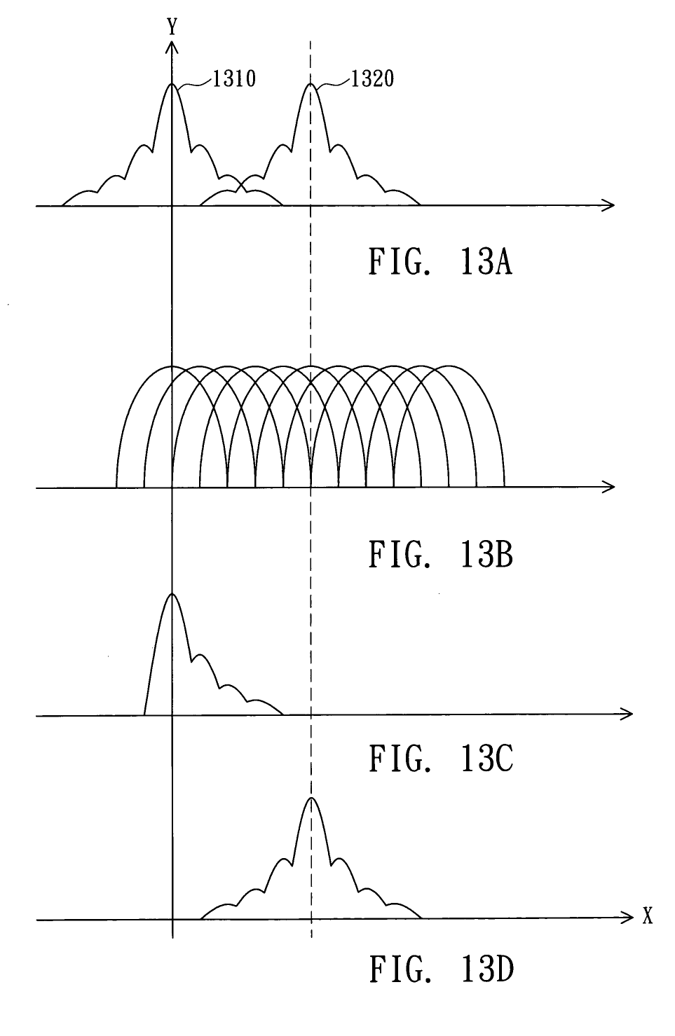

The memory can store m sets of pre-determined threshold values in the form of a look-up table to correspond to the different sets of output signals outputted individually from the m channels assigned to the transmitter 420. The reasoning can be better understood with reference to FIGS. 13A-D. As shown in FIG. 13A, it illustrates a couple of frequency spectra of the outputs signals transmitted by the transmitter 420. As shown in FIG. 13B, it illustrates the individual frequency response of the receiver channels, the receiver is shown with 11 bandpass channels with a bandwidth of 22 MHz. The channels are overlapped, and have a crossover region of 5 MHz. FIG. 13A illustrates frequency spectra 1310 and 1320 of the output signals transmitted from transmitter 420 as having single mainbeam and multiple sidelobes. The transmitter 420 for instance has 11 channels (m=11), with each channel being equidistant from one another, and frequency spectra 1310 and 1320 are for instance generated by channel 1 and channel 6 of the 11 channels, respectively. During the step of 1210, the selected channel of the m channels, such as channel 1, is to transmit the output signals with a frequency spectrum of 1310. Due to spectral alignment, the channels assigned to the receiver 410 only receive part the frequency spectrum 1310. Namely, suppose the spectral distribution of the channels of the transmitter and the receiver are drawn into perspective in FIGS. 13A and 13B, then the part of the frequency spectrum 1310 to the left with respect to the Y axis is out of the range of the channels of the receiver 410, and is therefore not detected. Consequently, the constructed frequency-domain pattern of the output signals, as received by the receiver 410, has the shape shown in FIG. 13C. In case of channel 6 of the m channels, on the other hand, the frequency spectrum 1320 generated therefrom is properly aligned with the n (=11) channels of the receiver 410. Thus, the constructed frequency-domain pattern of the output signals originating from channel 6 of the transmitter has the shape as shown in FIG. 13D. Thus, as shown, the memory may be preferable to store m sets of pre-determined threshold values to correspond to the different sets of output signals outputted individually from the m channels assigned to the transmitter 420.

Additionally, a check-result summary can be displayed according to the calculated power level differences and the pre-determined threshold values, such as in the form of a histogram, which can provide users a viewing on a display screen. The check-result summary may be used as a basis for tuning the high-limit power of the output signal such that the calculated power level differences are substantially equal to the corresponding pre-determined threshold values, thus satisfying the specification of, for instance, the Wi-Fi standard. An additional sub-step may further be included to check whether the n channels assigned to the receiver 410 have finished in receiving the output signals from all of the m channels assigned to the transmitter 420.

Accordingly, by applying the method of analyzing frequency spectrum, according to the embodiment of the invention serving the function of a conventional spectrum analyzer, costs, size and weight of the network apparatus are effectively minimized. The method can optimize the transmitter to fit the spectrum mask requirement which is particularly related to WiFi standard.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A network apparatus comprising a receiver, a transmitter, and an antenna, characterized in that the network apparatus comprising a link mode and a diagnostic mode, the network apparatus connecting to a network via the antenna in the link mode.

2. The network apparatus according to claim 1, wherein the network apparatus is tested for network connectivity at least in signal quality, link quality and quality of service.

3. The network apparatus according to claim 1, wherein the link mode further comprises a transmit mode and a receive mode, wherein the network apparatus further comprises a first switch operating under a predetermined protocol, wherein the first switch is configured such that the output signals from the transmitter are transmitted to the network in the transmit mode and incoming signals from the network reaches the receiver in the receive mode.

4. The network apparatus according to claim 3, wherein the predetermined protocol is link logic control (LLC).

5. The network apparatus according to claim 1, wherein the network apparatus is controlled by a test controller, the test controller monitoring connection status and making configuration and encryption settings to the transmitter and the receiver.

6. The network apparatus according to claim 1 further comprising an attenuator inter-disposed on a signal path between the transmitter and the receiver for emulating channel attenuation.

7. The network apparatus according to claim 6 further comprising a directional coupler and a second switch inter-disposed on a signal path between the transmitter and the receiver, wherein the second switch connects the attenuator to the receiver in the diagnostic mode, the output signals traveling from the transmitter to the receiver via the order of passing through the directional coupler and the attenuator.

8. The network apparatus according to claim 6 further comprising a directional coupler and a second switch inter-disposed on a signal path between the transmitter and the receiver, wherein the second switch connects the transmitter to the attenuator in the diagnostic mode, the output signals traveling from the transmitter to the receiver via the order of passing through the attenuator and the directional coupler.

9. The network apparatus according to claim 1 operating under a full duplex system, the network apparatus further comprising a first voltage-controlled oscillator and a second voltage controlled oscillator for controlling the transmitter and the receiver, respectively.

10. The network apparatus according to claim 1, the network apparatus further comprising a media access control (MAC), wherein the MAC self-test the network apparatus for network connectivity by generating output signals traveling from the transmitter to the receiver in the diagnostic mode.

11. The network apparatus according to claim 10, wherein the diagnostic mode comprises a transmit self-test mode, the MAC tunes the transmitter such that the output signals are output substantially at a predetermined maximum power level satisfying a predetermined transmitter packet error rate (PER).

12. The network apparatus according to claim 10, wherein the diagnostic mode comprises a receive self-test mode, the MAC tunes the transmitter such that the output signals are output substantially at a predetermined minimum power level satisfying a predetermined receiver PER.

13. The network apparatus according to claim 10, wherein the diagnostic mode comprises a crosslink self-test mode, the MAC tunes the transmitter such that the output signals are output at a characteristic crosslink power level satisfying a predetermined link quality indicator (LQI) and a predetermined indicator of quality of service (IQoS).

14. The network apparatus according to claim 1 being applied in a device controlled by a test controller, the test controller utilizes the network apparatus to connect the device to another one of said device having another one of said network apparatus applied therein, for performing mutual network connectivity between the two network apparatuses.

15. The network apparatus according to claim 1 being applied in a device controlled by a test controller, wherein the device is a personal computer, the test controller is a utility of the personal computer.

16. The network apparatus according to claim 1 being applied in a device controlled by a test controller, wherein the device is an embedded station in a basic service set (BSS) and the test controller is an AP in the BSS servicing the embedded station.

17. The network apparatus according to claim 1 being applied in a device controlled by a test controller, wherein the device is an access point (AP) in an extended service set (ESS) and the test controller is a server center in the ESS servicing the AP.

18. A method of self-testing network connectivity applied in a network apparatus, the network apparatus comprising a receiver, a transmitter, and an antenna, the method comprising:
outputting by the transmitter a plurality of output signals to the receiver;
optimizing uplink capability by tuning the transmitter, such that the output signals are output substantially at a predetermined maximum power level satisfying a predetermined transmitter packet error rate (PER);
checking downlink capability by tuning the transmitter, to see if the output signals are output substantially at a predetermined minimum power level satisfying a predetermined receiver PER; and
checking crosslink capability by tuning the transmitter to see if the output signals are output at a characteristic crosslink power level satisfying a predetermined link quality indicator (LQI) and a predetermined indicator of quality of service (IQoS).

19. The method according to claim 18, wherein the step of optimizing uplink capability comprises:
reading a first receiver signal quality indicator (SQI) associated with the output signals;
tuning the transmitter to output substantially at the predetermined maximum power level such that the first receiver SQI is less than or equal to a predetermined first max SQI;
reading a first receiver signal strength indicator (RSSI) associated with the output signals; and
tuning the transmitter to output the output signals substantially at the predetermined transmitter PER such that the first RSSI is within a predetermined RSSI range.

20. The method according to claim 18, wherein the predetermined RSSI range has a lower limit and an upper limit.

21. The method according to claim 18, wherein the step of checking downlink capability comprises:
reading a second receiver signal quality indicator (SQI) associated with the output signals;
tuning the transmitter to output substantially at the predetermined minimum power level such that the second receiver SQI is less than or equal to a predetermined second max SQI;
reading a second receiver signal strength indicator (RSSI) associated with the output signals; and
tuning the transmitter to output the output signals substantially at the predetermined receiver PER to see if the second RSSI is less than or equal to a predetermined maximum RSSI.

22. The method according to claim 18, wherein the step of checking crosslink capability comprises:
reading a link quality indicator (LQI) associated with the output signals;
tuning the transmitter to see if the LQI is greater than or equal to the predetermined LQI; and
reading an indicator of quality of service (IQoS) associated with the output signals; and
tuning the transmitter to see if the IQoS is less than or equal to the predetermined IQoS.

23. The method according to claim 18, wherein the network apparatus further comprising a media access control (MAC) with baseband processor.

24. A method of analyzing frequency spectrum, applied in a network apparatus for self-testing network connectivity, the network apparatus comprising a receiver, a transmitter, and an antenna, the network apparatus comprising a plurality of channels, the transmitter and the receiver being assigned of m and n channels of the plurality of channels, respectively, the method comprising:
transmitting a plurality of output signals at a high-limit power level by a selected channel of the m channels assigned to the transmitter;
receiving the output signals by the receiver via the assigned n channels;
calculating power level differences between selected channel and its adjacent channels of n channels assigned to the receiver; and
comparing the calculated power level differences with a plurality of pre-determined threshold values stored in a memory.

25. The method according to claim 24 further comprising generating another set of output signals at a high-limit power level by another selected channel of the remaining m channels assigned to the transmitter and returning to the step of receiving.

26. The method according to claim 24 further comprising:
displaying a check-result summary according to the calculated power level differences and the pre-determined threshold values; and
checking whether the n channels assigned to the receiver have complete in receiving the output signals from all of the m channels assigned to the transmitter.

27. The method according to claim 24 further comprising tuning the high-limit power of the output signals such that the calculated power level differences are substantially equal to or greater than the corresponding pre-determined threshold values.

28. The method according to claim 24, wherein the network apparatus further comprising a media access control (MAC) with baseband processor.
